(19) United States
(12) Patent Application Publication
(10) Pub. No.: US 2011/0244140 A1
(43) Pub. Date: Oct. 6, 2011

(54) METHOD OF MANUFACTURING TRANSPARENT CONDUCTIVE FILM

(75) Inventor: Nobuhiko TAKANO, Kanagawa (JP)

(73) Assignee: METHOD OF MANUFACTURING TRANSPARENT CONDUCTIVE FILM, Tokyo (JP)

(21) Appl. No.: 13/077,217

(22) Filed: Mar. 31, 2011

(30) Foreign Application Priority Data
Mar. 31, 2010 (JP) 2010-083085

(51) Int. Cl. B05D 5/12; C08J 7/18

(52) U.S. Cl. 427/488

(57) ABSTRACT

An atmospheric-pressure plasma-enhanced MOCVD (metal organic chemical vapor deposition) uses a power circuit for supplying power for plasma generation, including a pulse control circuit provided inside in order to form a transparent conductive film on the surface of the substrate, the transparent conductive film having a low resistivity, excellent optical characteristics and a good texture formed on the surface using dielectric barrier discharge.

### BACKGROUND OF THE INVENTION

The present invention relates to a method of manufacturing a transparent conductive film that enables stable formation of a transparent conductive film having low resistance and superior optical characteristics.

For example, as the upper electrode of a solar cell (electrode on the side nearest the light impinging surface), transparent conductive films such as zinc oxide, indium zinc oxide (IZO), indium tin oxide (ITO) and tin oxide are used. In particular, zinc oxide has the advantages that the raw material is plentiful and it has safety excellent enough to be used in pigments.

Sputtering has been widely used as the method of forming such transparent conductive films. Further, as a simple method to replace sputtering, research and development are being conducted in various places on MOCVD (metal organic chemical vapor deposition) using atmospheric pressure plasma.

For example, JP 2004-235004 A describes a film formation method for IZO transparent conductive film (formation method of IZO transparent conductive film) wherein, when forming an IZO transparent conductive film by atmospheric pressure plasma-enhanced CVD using dielectric barrier discharge, the oxygen concentration outside the discharge space is 2 vol % to 9 vol %, and voltage of a first frequency is applied to one of a pair of electrodes for dielectric barrier discharge, and voltage of a second frequency higher than the first frequency is applied to the other.

According to this film formation method, plasma density can be increased and a fine, good-quality IZO transparent conductive film can be formed by superimposing voltage of a second frequency onto voltage of a first frequency for initiating dielectric barrier discharge.

Further, as described in JP 11-284211 A, a transparent conductive film having a suitably concavo-convex structure (textured structure) on the surface can be formed by depositing a transparent conductive film by sputtering. Due to this textured structure, a light confinement effect is obtained due to light scattering, reflection loss and absorption loss can be reduced, and light use efficiency can be improved.

Incidentally, streamers (localized weak current) generated by the discharge unit have been cited as a cause of decreased quality of the formed film in atmospheric pressure plasma-enhanced CVD by dielectric barrier discharge of prior art, including the film formation method described in JP 2004-235004 A.

When streamers are generated by the discharge unit during formation of a transparent conductive film, disorder of crystal growth of the film is caused, and resistivity ends up becoming worse. That is, streamers tend to invite generation of particles. When particles are mixed into the film, growth of crystals from the substrate surface in the perpendicular direction is hindered, and as a result, crystal growth of the film ends up becoming inadequate. For this reason, when streamers are generated during film formation, particles end up mixing into the film, and the optical characteristics of the transparent conductive film end up decreasing.

Additionally, as also shown in JP 11-284211 A, transparent conductive film preferably has a textured structure on the surface. As described above, a transparent conductive film having an appropriately textured structure can be formed by sputtering at low pressure, as shown in JP 11-284211 A.

However, although it is not thought to be difficult to produce this transparent conductive film having a textured structure when film formation is performed at low pressure, it is difficult to obtain such a textured structure if the transparent conductive film is formed by treating a large-area film roll, etc., at atmospheric pressure.

In the present state of the art in MOCVD by atmospheric pressure plasma, it is possible to form a textured transparent conductive film by crystal growth from a substrate having a concavo-convex structure, but it is difficult to form a transparent conductive film having an advantageous texture on the surface by depositing the transparent conductive film on a flat substrate.

The objective of the present invention is to solve the problems of the above-described prior art, and to provide a method of manufacturing a transparent conductive film which suppresses generation of streamers during film formation and reduces the mixing of particles into the film caused by streamer generation when a transparent conductive film is formed by MOCVD by atmospheric pressure plasma using dielectric barrier discharge, whereby a transparent conductive film can be formed with high productivity, on the surface of which an advantageous texture (concavo-convex structure) is formed even when there is no appropriate concavo-convex structure on the film formation surface, and which has good optical characteristics and low resistivity.

### SUMMARY OF THE INVENTION

In order to achieve the above object, according to the present invention, there is provided a method of manufacturing a transparent conductive film, including: using a raw material gas obtained by vaporizing an organic compound selected from a zinc organic compound, a tin organic compound and an indium organic compound, and a gas containing oxygen atom, supplying power for plasma generation to a pair of electrodes from a power circuit having a power source generating a single-frequency sine wave, and a pulse control circuit, and generating dielectric barrier discharge at/near an atmospheric pressure to form a transparent conductive film by plasma-enhanced CVD.

In the method of manufacturing a transparent conductive film according to the present invention, it is preferable that the said gas containing oxygen atom contains ozone. Further, it is preferable that the power source applies a voltage between said pair of electrodes, said pulse control circuit generates at least one voltage pulse during a half cycle, and a displacement current pulse between said pair of electrodes is generated with generation of the voltage pulse. Further, it is preferable that the pulse control circuit contains at least one choke coil. Further, it is preferable that the choke coil goes into a saturated state during a pulse following a maximum pulse in which said power source applied a voltage between said pair of electrodes. Further, it is preferable that the transparent conductive film is fabricated by remote plasma. Further, it is preferable that the said power source uses a power source generating a single-frequency sine wave at 20 kHz to 3 MH. Further, it is preferable that the transparent conductive film is formed with a substrate temperature at 150° C. or above. Further, it is preferable that the zinc organic compound is used as said organic compound. Furthermore, it is preferable that the zinc organic compound is a complex compound containing Zn and Al, or a compound expressed by Zn(CₓH_{y}O_{z})ₘ.

According to the present invention having a configuration described above, in a transparent conductive film formation by atmospheric pressure plasma-enhanced MOCVD using dielectric barrier discharge, generation of streamers during discharge can be advantageously suppressed, mixing of particles into the film caused by streamers can be prevented, and worsening of resistivity due to inadequate crystal growth caused thereby can be prevented, and additionally, a transparent conductive film having an advantageous surface texture due to good crystal growth can be formed.

Therefore, according to the present invention, a transparent conductive film having low resistivity and high optical characteristics as well as a high light confinement effect due to a good textured structure can be stably produced. Moreover, according to the present invention, a transparent conductive film having these superior characteristics can be produced with higher productivity than film formation by sputtering, etc., because MOCVD is used at atmospheric pressure.

### BRIEF DESCRIPTION OF THE DRAWINGS

FIG. 1 is a schematic view showing a film formation apparatus for implementing the method of manufacturing a transparent conductive film of the present invention.

### DETAILED DESCRIPTION OF THE INVENTION

Next, the method of manufacturing a transparent conductive film of the present invention is described in detail by referring to the preferred embodiments shown in the accompanying drawings.

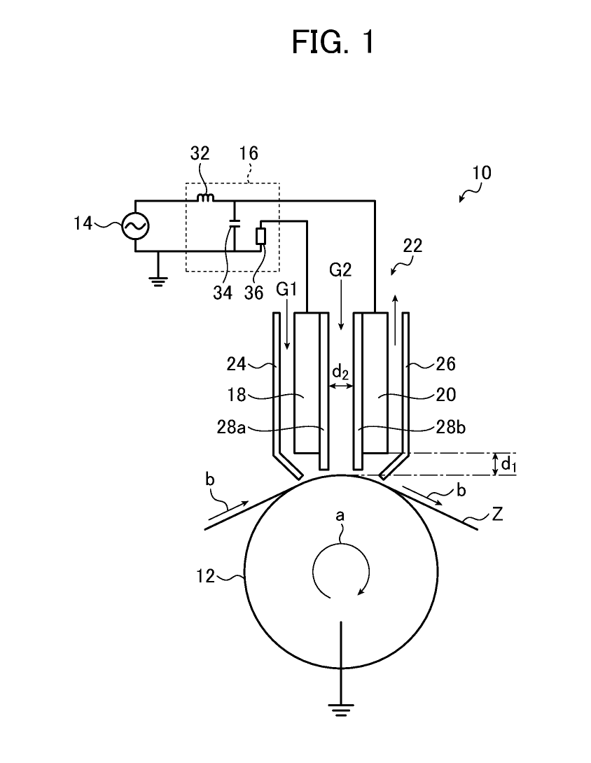

FIG. 1 is a schematic view showing a film formation apparatus for implementing the method of manufacturing a transparent conductive film of the present invention.

The film formation apparatus 10 shown in FIG. 1 forms a transparent conductive film such as a zinc oxide transparent conductive film on the surface of a substrate Z by MOCVD (metal organic chemical vapor deposition) by atmospheric pressure plasma using dielectric barrier discharge.

The film formation apparatus 10 shown in FIG. 1 comprises, for example, a drum 12, a power source 14, a matching circuit 16, a ground side electrode 18, a high voltage electrode 20, flow path members 24 and 26, which form the gas flow paths, and insulating plates 28a and 28b. Note that in the description below, the insulating plates 28a and 28b together are also called insulating plates 28.

This film formation apparatus 10 performs film formation on the substrate Z by so-called remote plasma, wherein the plasma generation region and the film formation region (gaseous raw material supply region) are different regions.

In the production method of the present invention, as the substrate Z, various substrates Z may be used without particular limitation as long as it is substrate on which a zinc oxide transparent conductive film, indium oxide transparent conductive film and tin oxide transparent conductive film can be formed by atmospheric pressure plasma-enhanced CVD using dielectric barrier discharge.

Specific examples of the substrate Z that may be advantageously used include polymer films (plastic films/resin films) made of organic materials such as polyethylene terephthalate (PET), polyethylene naphthalate, polyethylene, polypropylene, polystyrene, polyamide, polyvinyl chloride, polycarbonate, polyacrylonitrile, polyimide, polyacrylate and polymethacrylate.

Further, the substrate Z used in the present invention may be a sheet consisting of a base material such as this type of polymer film, on top of which are formed layers (films) for imparting various functions, such as a protective layer, an adhesive layer, a light-reflecting layer, a light-shielding layer, a planarizing layer, a buffer layer and a stress-relief layer.

In the illustrated film formation apparatus 10, the substrate Z is, for example, loaded as a substrate roll that was wound into a roll (not shown), and pulled out from the substrate roll and supplied to the film formation apparatus 10. Further, the substrate Z on which film formation has been completed is again wound into a roll (not shown) and supplied to the next process.

That is, the illustrated film formation apparatus 10 performs film formation by a so-called roll-to-roll system, wherein film formation is performed in a predetermined region on the drum 12 while the substrate Z is fed out from the substrate roll and fed in the longitudinal direction, and the substrate Z on which film formation has been completed is wound into a roll.

The drum 12 is a cylindrical member formed of stainless steel, etc., which feeds the substrate Z in the longitudinal direction (direction of arrow b in the drawing) while maintaining it in the predetermined film formation position, by rotation (direction of arrow a in the drawing) while winding the substrate Z on the circumferential surface.

Further, in the illustrated example, the drum 12 is grounded.

The drum 12 preferably has a built-in temperature adjusting means for adjusting the temperature of the substrate Z during film formation, that is, the film formation temperature. Note that as the temperature adjusting means, various known means, such as a means which circulates a temperature adjusting medium such as temperature-adjusted insulating oil or water, various heaters, or a cooling media such as a Peltier element, may be used without particular limitation.

The ground side electrode 18 and the high voltage electrode 20 form an electrode pair 22 for generating dielectric barrier discharge (DBD).

The ground side electrode 18 and the high voltage electrode 20 are known components used in atmospheric pressure plasma-enhanced CVD by dielectric barrier discharge, and are plate-like members made of, for example, stainless steel.

In the illustrated example, the ground side electrode 18 and the high voltage electrode 20 are arranged in parallel, separated by a predetermined distance in the feeding direction of the substrate Z. Further, the ground side electrode 18 and the high voltage electrode 20 are arranged parallel to the diametric direction of the drum 12, such that the bottom edge (edge nearest the drum) is separated from the drum 12 by distance d1.

This distance d1 (that is, the distance between the substrate Z and electrode pair in the film formation region) can be appropriately set without particular limitation in accordance with film formation conditions, etc., similar to that in known devices that perform CVD by remote plasma, but 2 mm to 10 mm is preferred, and 2 mm to 6 mm is particularly preferred.

The insulating plates 28 (28a and 28b) are both known insulating plates (dielectric plates) used in dielectric barrier discharge; for example, they are plate-like members formed of various insulating materials (dielectrics) such as various glasses, various ceramics, or various resin materials such as PET (polyethylene terephthalate) or PEN (polyethylene naphthalate).

In the film formation apparatus 10, the insulating plate 28a is affixed to the ground side electrode 18, and the insulating plate 28b is affixed to the high voltage electrode 20. The insulating plates 28 are both arranged so as to cover the entire opposing surfaces of the ground side electrode 18 and the high voltage electrode 20.

Further, insulating plates 28a and 28b are arranged so as to be separated from each other by a predetermined distance (gap d2) in the feeding direction of the substrate Z. Additionally, insulating plates 28a and 28b are both arranged so as to be separated from the drum 12 by a distance shorter than the above-described distance d1.

The space between the insulating plates 28a and 28b serves as the supply path of gas G2 (for convenience, also referred to as “film forming gas G2” hereinafter) which contains gaseous raw material obtained by vaporizing the organic compound. This space between the insulating plates 28 is the space where dielectric barrier discharge is performed, as well as the space where plasma is generated.

Note that in the gap d2 between the insulating plate 28a and the insulating plate 28b, which serves as the space where dielectric barrier discharge is performed, can be appropriately set without particular limitation in accordance with film formation conditions, etc., similar to the distance d1, but 0.1 mm to 1 mm is preferred, and 0.3 mm to 0.8 mm is particularly preferred.

In the present invention, the gap d2 between the insulating plate 28a and the insulating plate 28b is preferably smaller than the distance d1 between the ground side electrode 18 and high voltage electrode 20 and the drum 12 (that is, it is preferred that d2<d1).

If the distance d1 between the ground side electrode 18 and high voltage electrode 20 and the drum 12 is too small, depending on film formation conditions, there may be cases where discharge ends up being performed between the high voltage electrode 20 and the drum 12, but by setting d2 to be smaller than d1, discharge between the high voltage electrode 20 and the drum 12 can be prevented, and discharge can be reliably performed between the insulating plate 28a and the insulating plate 28b.

The flow path member 24 is arranged so as to be separated from the insulating plate 28a by a predetermined distance, with the ground side electrode 18 in between them. On the other hand, the flow path member 26 is arranged so as to be separated from the insulating plate 28b by a predetermined distance, with the high voltage electrode 20 in between them.

The gap between the flow path member 24 and the insulating plate 28a serves as the supply path of gas G1 which contains oxygen atoms (for convenience, also referred to as “oxygen atom supply gas G1” hereinafter). Further, the gap between the flow path member 26 and the insulating plate 28b serves as the evacuation path of the oxygen atom supply gas G1 and film forming gas G2. Correspondingly, the flow path members 24 and 26 both extend to the vicinity of the drum 12 (substrate Z) by the bottom end vicinity being bent to the inside (side nearest the insulating plate 28).

Note that as the material that forms the flow path members 24 and 26, various hard insulating materials, such as alumina or PEEK (polyetheretherketone) may be advantageously used without particular limitation.

In the film formation apparatus 10, power for plasma generation (plasma excitation power) is applied between the ground side electrode 18 and the high voltage electrode 20, and dielectric barrier discharge thereby occurs, and the oxygen atom supply gas G1 is supplied to the plasma that spews out from between the ground side electrode 18 and the high voltage electrode 20 and reaches the substrate Z due to gas flow of the film forming gas G2, and oxygen radicals, etc., are thereby generated above the substrate Z.

Further, the film forming gas G2 is supplied between the insulating plates 28a and 28b. The film forming gas G2 is decomposed by the plasma between these insulating plates 28 and blown above the substrate Z, where it reacts with oxygen radicals, and a transparent conductive film is thereby formed on the substrate Z.

As shown in JP 2004-235004 A, in formation of a transparent conductive film by ordinary atmospheric pressure plasma-enhanced CVD using dielectric barrier discharge (film formation by so-called direct CVD), the transparent conductive film ends up being formed on the surface of the insulators as well, because film forming gas is supplied between the insulators (dielectrics) that cover the electrodes, which is the region where plasma is generated.

As a result, secondary electrons are released from the generated transparent conductive film, making it difficult to maintain uniform glow discharge plasma (plasma is unstable). For this reason, formation of the transparent conductive film becomes unstable, and problems such as defect generation and non-uniformity of film thickness occur.

In contrast, in film formation by remote plasma as in the illustrated film formation apparatus 10, the oxygen atom supply gas G1 which contains oxygen atoms is not supplied to the plasma generation region, that is, the gap between the insulating plates 28, but is supplied to the film formation region at the bottom of the plasma generation region. Further, as described above, the plasma generated in the plasma generation region is transferred downward by the gas flow of the film forming gas G2, and it comes in contact with the oxygen atom supply gas G1 and the plasma in the vicinity of the substrate Z outside the plasma generation region. Due to this contact between the oxygen atom supply gas G1 and the plasma, the oxygen atom supply gas G1 is further activated, and a reaction occurs between the oxygen atoms and the raw material, and the transparent conductive film is formed on the substrate Z.

Therefore, in the film formation apparatus 10, since the excited gaseous raw material does not contact the insulating plates 28, film formation on the insulating plates 28 can be advantageously prevented. For this reason, an appropriate transparent conductive film wherein the generation of defects, etc., is suppressed can be stably formed on the substrate Z.

In order to generate atmospheric-pressure plasma by dielectric barrier discharge at atmospheric pressure, the power source 14 applies a voltage (supplies power for plasma generation (plasma excitation power)) to the electrode pair 22 (between the ground side electrode 18 and the high voltage electrode 20).

In the present invention, as the power source 14, various known power sources used in film formation by atmospheric pressure plasma-enhanced CVD by dielectric barrier discharge may be used without particular limitation. Specifically, examples include power sources that generate power of a single-frequency sine wave, among which power sources of frequency 20 kHz to 3 MHz are preferred, among which power sources of frequency 100 kHz to 450 kHz are particularly preferred.

The power source 14 is connected to the electrode pair 22 (the ground side electrode 18 and the high voltage electrode 20) through the matching circuit 16.

The matching circuit 16 performs impedance matching between the power source 14 and the electrode pair 22 (including the gap d2) to reduce the power reflection returning from the electrode pair 22 to the power source 14.

In the illustrated example, the matching circuit 16 is constructed of a matching coil 32 connected in series with the electrode pair 22, a capacitor 34 connected in parallel with the electrode pair 22, and a pulse control circuit 36 connected in series with the matching coil 32 so as to sandwich the electrode pair 22.

The pulse control circuit 36 is a characteristic component of the present invention, which improves the quality of the transparent conductive film by suppressing generation of streamers during film formation, and additionally, it forms an advantageous textured structure on the surface of the transparent conductive film by growing the crystals oriented on the c axis.

As described above, in film formation by atmospheric pressure plasma-enhanced CVD using dielectric barrier discharge, streamers (faint localized current) generated by the discharge unit are known to be a cause of reduced film quality, etc.

As described above, when streamers are generated during formation of the transparent conductive film, crystal growth of the film is hindered, and resistivity is not decreased, and in addition, particles caused by streamers end up mixing into the film, and the optical characteristics of the transparent conductive film becomes degraded.

In contrast, according to the method of manufacturing a transparent conductive film of the present invention, in atmospheric pressure plasma-enhanced CVD using dielectric barrier discharge, generation of streamers in the discharge unit during film formation of the transparent conductive film can be suppressed due to the fact that the power circuit that applies voltage for plasma generation to the electrode pair has a pulse control circuit.

As a result, carrier gas, gaseous raw material and oxygen atoms can be excited in a location near the substrate Z by inducing a uniform glow discharge, and as a result, crystals advantageously oriented on the c axis are obtained, and a transparent conductive film having low resistivity can be formed. Further, since streamers can be suppressed, generation of particles caused by them can also be suppressed, and a transparent conductive film with suppressed particle entrainment into the film and having excellent optical characteristics can be formed. Additionally, due to the fact that the crystals advantageously oriented on the c axis grow, a transparent conductive film having good texture on the surface, wherein advantageous irregularities are formed on the surface, can be formed even when the substrate surface is flat.

Further, since very few particles are mixed in, a transparent conductive film having low resistivity can be formed because the obstruction to crystal growth stated above is expelled, and the crystals of the film grow in order, as described above.

Additionally, the gaseous raw material can be advantageously decomposed and a good-quality transparent conductive film can be formed because high-output power for plasma generation can be applied due to stabilized discharge. For example, when a zinc oxide transparent conductive film is formed, the carbon components that bond with zinc in the zinc organic compound that serves as the gaseous raw material can be almost completely decomposed, and as a result, a good-quality zinc oxide transparent conductive film can be formed.

That is, according to the present invention, a highly efficient transparent conductive film having low resistivity and excellent optical characteristics as well as a high light confinement effect by light scattering, on which a good texture has been formed on the surface, can be stably produced.

Moreover, since the production method of the present invention is plasma-enhanced CVD at atmospheric pressure, film formation is possible at a low temperature near 100° C., and a transparent conductive film can be formed on a polymer film having low resistance to heat, such as PET or PEN.

Further, compared to sputtering, etc., a transparent conductive film can be formed without damaging the substrate Z, and additionally, the film formation speed is fast, and a transparent conductive film having excellent characteristics as described above can be formed with high productivity.

In the present invention, when a voltage to excite plasma (that is, voltage for generating dielectric barrier discharge) is applied to the electrode pair 22, the pulse control circuit 36 generates at least one pulse voltage in a half cycle to generate a displacement current pulse between the electrode pair 22, thereby suppressing streamers and stabilizing the plasma.

A specific advantageous example of the pulse control circuit 36 is a choke coil connected in series to the electrode pair 22. A particularly advantageous example is a choke coil configured such that it goes into the saturated state during the pulse after the maximum pulse (maximum voltage) (during the same cycle of the sine wave), when sine wave voltage of the same frequency is applied by the power source 14 to the electrode pair 22.

Since the choke coil has non-linear response, it rapidly changes the voltage between the electrodes of the electrode pair 22 at a certain current. As a result, it can vary the displacement current between the insulators 28 (in the discharge gap), and can suppress generation of streamers.

Note that displacement current does not mean that charged particles actually flow between the insulator 28a and the insulator 28b, but it is observed as a change in voltage.

In particular, as the pulse control circuit 36, a choke coil that transitions from the saturated state to the unsaturated state during the pulse after the maximum pulse when sine wave voltage of the same frequency is applied by the power source 14 to the electrode pair 22 is preferred. By using such a choke coil, a desirable result is obtained, in the sense that plasma cut-off is induced quickly and residual streamers can be advantageously eliminated.

Note that the choke coil serving as the pulse control circuit 36 is not limited to one choke coil, and a plurality of choke coils may be used as the pulse control circuit. Further, another pulse control circuit may be used in combination with the choke coils serving as a pulse control circuit.

As described below, in the case where a plurality of choke coils are used as the pulse control circuit, it is preferred that at least one choke coil transitions from the saturated state to the unsaturated state during the pulse after the maximum pulse as described above, and it is particularly preferred that all choke coils transition from the saturated state to the unsaturated state.

Note that in the present invention, the pulse control circuit 36 is not limited to a choke coil, and various pulse control circuits (pulse control elements) having the above-described operation may be used.

For example, a pulse control circuit 36 made up of a choke coil connected in series to the electrode pair 22 and a capacitor connected in parallel to this choke coil may be advantageously used. Further, a pulse control circuit 36 made up of a choke coil connected in series to the electrode pair 22 similar to the pulse control circuit 36, and a (resonator) capacitor connected in series to this choke coil, and a (pulse) capacitor connected in parallel to the series circuit of the choke coil and capacitor, may be advantageously used.

Such a pulse control circuit 36 (a matching circuit that incorporates a pulse control circuit, and a power circuit having a power source and a matching circuit) is described in detail in JP 2007-520878 T and JP 2009-506496 T. The production method of the present invention may use any pulse control circuit and power circuit disclosed in these two patent application publications.

Further, in the production method of the present invention, various known resonator circuits may be used as the LC resonator circuit portion in the matching circuit, in addition to the configuration disclosed in the exemplary drawings and the above patent application publications. For example, as shown in Appl. Phys. Lett., 91, 081504 (2007), a parallel LC resonator circuit may also be advantageously used by connecting the pulse control circuit such as a choke coil in series with the electrode pair.

Additionally, a configuration wherein a transformer is arranged between the power source 14 and the matching circuit 16 may also be used, and the same effect as the example shown in FIG. 1 can be obtained.

The method of manufacturing a transparent conductive film of the present invention forms either a zinc oxide transparent conductive film, a tin oxide transparent conductive film or an indium oxide transparent conductive film as the transparent conductive film.

The production method of the present method is more appropriately used in formation of a zinc oxide transparent conductive film, in the sense that a textured structure can be advantageously formed on the film surface, and, as described above, the raw material is plentiful and has excellent safety.

As the organic compound serving as the gaseous raw material in the production method of the present invention, various zinc organic compounds, tin organic compounds and indium organic compounds may be used without particular limitation in accordance with the transparent conductive film to be formed.

Specifically, as zinc organic compounds, advantageous examples include complex compounds containing Zn and Al such as zinc diisobutylmethanate-aluminum triisobutylmethanate (Zn(DIBM)₂-Al(DIBM)₃) and zinc diisobutylpivanoylmethanate-aluminum triisobutylpivanoylmethanate (Zn(IBPM)₂-Al(IBPM)₃), and compounds expressed by Zn(CₓH_{y}O_{z})ₘ such as zinc acetylacetonate (Zn(C₅H₇O₂)₂), as well as diethyl zinc (Zn(C₂H₅)₂) and zinc bis-2,4-octanedionate (Zn(OD)₂), etc.

Among these, complex compounds containing Zn and Al and compounds expressed by Zn(CₓH_{y}O_{z})ₘ are advantageously used.

Further, as tin organic compounds, examples include dibutyldiethoxy tin, tetraethoxy tin, methylmethoxy tin, diethyidiethoxy tin, triisopropylethoxy tin, dibutoxy tin, diethyl tin, diacetoxy tin, dibutoxydiacetoxy tin, 2,4-pentanedionate-ethoxy tin, 2,4-pentanedionate-dimethyl tin, etc.

Additionally, as indium organic compounds, advantageous examples include indium tridipivaloylmethanate (In(DPM)₃), indium tridiisobutylmethanate (In(DIBM)₃), indium rriisobutylpivanoylmethanate (In(IBPM)₃), indium tri-2,2,6,6-tetramethyl-3,5-octanedionate (In(TMOD)₃), trimethyl indium ((CH₃)₃In), etc.

Such organic compounds are used as the gaseous raw material obtained by vaporization by known methods, which is mixed with nitrogen, etc., as a carrier gas to form the film forming gas G2, which is supplied between the insulating plate 28a and insulating plate 28b by various known means used in CVD, etc.

Note that various gases used as carrier gases (dilution gases) in plasma-enhanced CVD, such as nitrogen gas, argon gas and helium gas, may be used as the carrier gas.

Further, in the present invention, various gases used in MOCVD that uses zinc organic compounds, indium organic compounds and tin organic compounds as gaseous raw material may be added to the film forming gas G2 (or the oxygen atom supply gas G1).

For example, trimethyl aluminum ((CH₃)₃Al) or triethyl aluminum (Al(C₂H₅)₃) may be added to the film forming gas G2 for the purpose of reducing resistivity. Further, diborane (B₂H₆) may also be added to the film forming gas G2.

Further, not only can aluminum compounds be used, but compounds of gallium and indium may be used to form a GZO film or IGZO film. Examples of these raw materials include trimethyl indium ((CH₃)₃In), trimethyl gallium ((CH₃)₃Ga), trimethyl gallium ((C₂H₅)₃Ga), etc.

The oxygen atom supply gas G1 is a gas that contains oxygen atoms. Various gases may be used provided that they contain oxygen atoms.

Specific advantageous examples include mixed gas of carbon dioxide and oxygen, mixed gas of water vapor and oxygen, etc. For mixed gases of carbon dioxide and oxygen, gases with a carbon dioxide:oxygen ratio of 1:1 are preferred, and gases containing ozone in that gas are particularly preferred, among which gases containing 100 ppm to 1000 ppm ozone are most preferred. Further, for mixed gases of water vapor and oxygen, gases containing oxygen that is saturated in the moisture content are preferred, and gases containing ozone in that gas are particularly preferred, among which gases containing 100 ppm to 1000 ppm ozone are most preferred.

In the method of manufacturing a transparent conductive film of the present invention, the film formation conditions are not particularly limited, and may be appropriately set in accordance with the type of transparent conductive film to be formed, the types of film forming gas G2 and oxygen atom supply gas G1 used, the thickness of the transparent conductive film, the film formation rate, etc., similar to various methods of formation of transparent conductive elements by atmospheric pressure plasma-enhanced CVD using dielectric barrier discharge.

According to research by the inventors, in the production method of the present invention, the higher the film formation temperature (substrate temperature), the better the quality of the obtained transparent conductive film, in the sense that an advantageous textured structure can be formed, etc.

For this reason, in the present invention, the transparent conductive film is preferably formed at a film formation temperature of 150° C. or above.

Note that the method for adjusting the film formation temperature may be performed by a known means. For example, when the film formation apparatus 10 shown in FIG. 1 is used, formation of the transparent conductive film may be performed with the temperature of the substrate Z adjusted to 150° C. or above by a temperature adjusting means built into the drum 12.

Note that in the present invention, a transparent conductive film having low resistivity, high optical characteristics and a good texture formed on the surface can be formed even at low temperature.

That is, as described above, the production method of the present invention may be advantageously used in formation of a transparent conductive film even on a polymer film having low resistance to heat such as PET or PEN.

Further, the film formation pressure is not particularly limited, and may be the same as in known atmospheric pressure plasma-enhanced CVD, but film formation is preferably performed at 20 kPa to 110 kPa.

While the method of producing a transparent conductive film according to the present invention has been described above in detail, the present invention is by no means limited to the foregoing examples, and it should be understood that various improvements and modifications may of course be made without departing from the scope and spirit of the present invention.

For example, the illustrated film formation apparatus 10 performs continuous film formation on the long substrate Z by a roll-to-roll system, but the present invention is not limited thereto, and may also be advantageously used in a apparatus that performs film formation in batches on sheets, etc.

### EXAMPLES

Next, the present invention is described in further detail by referring to the following examples.

### Example 1

The film formation apparatus 10 shown in FIG. 1, which performs film formation by atmospheric pressure plasma-enhanced CVD by dielectric barrier discharge (DBD), was used to form a zinc oxide transparent conductive film with a thickness of 150 nm on the surface of a substrate Z.

As the substrate Z, a polyimide film with a thickness of 0.1 mm was used.

As the oxygen atom supply gas G1, 99.999% oxygen was used. The oxygen atom supply gas G1 was made to flow at a rate of 10 liters per minute, and by passing it through a UV radiation device, ozone was generated and then supplied between the flow path member 24 and the insulating plate 28a. Note that the UV radiation device irradiated ultraviolet light of 185 nm and 254 nm using the ozone lamp NIQ120/44U made by Heraeus. The radiation intensity was 0.06 W/cm².

Diethyl zinc (Zn(C₂H₅)₂) was supplied (4 g/hour) as a liquid to a vaporizer and was vaporized while heating to 100° C., and this was used as the gaseous raw material. Using nitrogen gas as a carrier gas (flow rate 2 L/minute), the vaporized diethyl zinc was supplied between the insulating plates 28a and 28b, so as to hold the pressure inside the vaporizer at 0.01 MPa above atmospheric pressure.

Additionally, a toluene solution of Al(DIBM)₃ in a concentration of 0.05 mol/L was prepared. This solution was introduced into the vaporizer at a flow rate of 0.1 g/hour, and by heating it to 200° C., the Al(DIBM)₃ was vaporized, and gaseous raw material was obtained. Using nitrogen gas as a carrier gas (flow rate 2 L/minute), this gaseous raw material was supplied between the insulating plates 28a and 28b, so as to hold the pressure inside the vaporizer at 0.01 MPa above atmospheric pressure, and it was mixed with the previous diethyl zinc to form the film forming gas G2.

The power source 14 was a 150 kHz sine wave power source that applies voltage of amplitude 4 kV between the ground side electrode 18 and the high voltage electrode 20. The plasma excitation power was 1000 W.

The pulse control circuit 36 of the matching circuit 16 was a toroidal inductor having saturation flux Bₛₐₜ of 350 mT. The inductance of the pulse control circuit 36 was 1 mH at 100 kHz.

The feed rate of the substrate Z was 0.3 m/minute. Note that during film formation, the film formation temperature was controlled to 150° C. by holding the temperature of the drum 12 at 150° C. by recirculation of insulating oil.

The film formation rate was 1200 nm/minute.

### Example 2

A zinc oxide transparent conductive film with a thickness of 150 nm was formed on the surface of a substrate Z in the same way as in example 1, except that trimethyl aluminum (TMAl) was used instead of Al(DIBM)₃ as the gaseous raw materials (film forming material).

Note that TMAl was supplied (0.1 g/hour) to the vaporizer as a liquid at 100° C., and it was vaporized while being sprayed, to form the gaseous raw material. Using nitrogen gas as a carrier gas (flow rate 2 L/minute), the vaporized TMAl was supplied between the insulating plates 28a and 28b, and it was mixed with diethyl zinc to form the film forming gas G2.

The film formation rate was 1200 nm/minute.

### Example 3

A zinc oxide transparent conductive film with a thickness of 150 nm was formed on the surface of a substrate Z in the same way as in example 1, except that Zn(OD)₂ was used instead of diethyl zinc as the gaseous raw material (film forming raw material).

Note that a toluene solution of Zn(OD)₂ in a concentration of 0.05 mol/L was used to supply Zn(OD)₂. This solution was introduced into the vaporizer at a flow rate of 0.1 g/hour, and by heating it to 200° C., the Zn(OD)₂ was vaporized, and gaseous raw material was obtained. Using nitrogen gas as a carrier gas (flow rate 2 L/minute), this gaseous raw material was supplied between the insulating plates 28a and 28b, so as to hold the pressure inside the vaporizer at 0.01 MPa above atmospheric pressure, and it was mixed with Al(DIBM)₃ to form the film forming gas G2.

The film formation rate was 1100 nm/minute.

### Example 4

A zinc oxide transparent conductive film with a thickness of 150 nm was formed on the surface of a substrate Z in the same way as in example 3, except that the input power was 600 W, the flow rate of the toluene solution of Zn(OD)₂ put into the vaporizer was 2 g/hour, the flow rate of the toluene solution of Al(DIBM)₃ put into the vaporizer was 0.05 g/hour, and the film formation rate was 500 nm/minute.

### Comparative Example 1

A zinc oxide transparent conductive film with a thickness of 150 nm was formed on the surface of a substrate Z in the same way as in example 3, except that in the film formation apparatus 10, the pulse control circuit 36 was not used in the matching circuit 16, and as the power for plasma generation, superimposed power of dielectric barrier discharge (DBD) and 13.56 MHz RF power (superimposition of 700 W and 300 W) was supplied.

The film formation rate was 1100 nm/minute.

### Comparative Example 2

A zinc oxide transparent conductive film with a thickness of 150 nm was formed on the surface of a substrate Z in exactly the same way as in example 1, except that in the film formation apparatus 10, the pulse control circuit 36 was not used in the matching circuit 16.

The film formation rate was 1200 nm/minute.

The resistivity and light confinement effect of the seven obtained zinc oxide transparent conductive films were checked. Further, from both of these results, they were evaluated as zinc oxide transparent conductive films.

### (Resistivity)

The substrate Z was peeled off, aluminum was vapor-deposited on the surface of the zinc oxide transparent conductive film, and the resistivity (Ω-cm) of the zinc oxide transparent conductive film was measured by the four-point probe method.

The results were 2×10⁻⁴ Ω-cm for example 1, 4×10⁴ Ω-cm for example 2, 3×10⁻⁴ Ω-cm for examples 3 and 4, 8×10⁻² Ω-cm for Comparative example 1, and 6×10⁻³ Ω-cm for Comparative example 2. Further, resistivity was evaluated as follows.

⊚: Resistivity<4×10⁻⁴ Ω-cm

◯: 4×10⁻⁴ Ω-cm≦Resistivity<1×10⁻³ Ω-cm

Δ: 1×10⁻³ Ω-cm≦Resistivity<1×10⁻² Ω-cm

x: Resistivity≧1×10² Ω-cm

### (Light Confinement Effect)

The substrate Z was peeled off, and the surface of the zinc oxide transparent conductive film was observed by AFM (atomic force microscope). The light confinement effect of the zinc oxide transparent conductive film was evaluated by measuring the center line average roughness Ra (measurement length=10 micrometers). The higher the value of Ra, the higher the light confinement effect it was considered to have, as it was judged that a textured structure was efficiently generated. The evaluations were as follows.

⊚: Ra>200 nm

◯): 50 nm<Ra≦200 nm

Δ: 10 nm<Ra≦50 nm

x: Ra≦10 nm

### (Evaluation)

For resistivity and light confinement effect, ⊚ was given 3 points, ◯ was given 2 points, Δ was given 1 point, and x was given 0 points. These were totaled, and the overall evaluation of the film was scored as follows:

⊚: Total of 5 points or more

◯: Total of 4 points

Δ: Total of 3 points

x: Total of 2 points or less

The results are shown in Table 1

TABLE 1

| | | | | Film | | | |
|---|---|---|---|---|---|---|---|
| | | Pulse | | formation | | Light | |
| | Excitation | control | Film forming raw | rate | Resistivity | confinement | |
| | method | element | material | (nm/minute | (Ω-cm) | effect | Evaluation |
| Example 1 | DBD | Used | Zn(C₂H₅)₂ + Al (DIBM)₃ | 1200 | 2 × 10⁻⁴ | ⊚ | ⊚ |
| Example 2 | DBD | Used | Zn(C₂H₅)₂, + TMAl | 1200 | 4 × 10⁻⁴ | ⊚ | ⊚ |
| Example 3 | DBD | Used | Zn(OD)₂ + Al (DIBM)₃ | 1100 | 3 × 10⁻⁴ | ⊚ | ⊚ |
| Example 4 | DBD | Used | Zn(OD)₂ + Al (DIBM)₃ | 500 | 3 × 10⁻⁴ | ⊚ | ⊚ |
| Comparative | DBD + RF | Not | Zn(OD)₂ + Al (DIBM)₃ | 1100 | 8 × 10⁻² | Δ | x |
| example 1 | | used | | | | | |
| Comparative | DBD | Not | Zn(C₂H₅)₂ + Al (DIBM)₃ | 1200 | 6 × 10⁻³ | ○ | Δ |
| example 2 | | used | | | | | |

As shown in Table 1, the zinc oxide transparent conductive films formed by the production method of the present invention had extremely low resistivity and a good light confinement effect. In particular, good resistivity for a Zn-based transparent conductive film of 2×10⁻¹ Ω-cm was obtained in the zinc oxide transparent conductive film of example 1.

In contrast, Comparative example 1 and Comparative example 2, in which the matching circuit 16 did not have a pulse control circuit 36, had higher resistivity and a lower light confinement effect than example 3 and example 1, which were otherwise prepared under the same conditions.

The results as described above demonstrate the merits of the present invention.

### INDUSTRIAL APPLICABILITY

The present invention can be advantageously used in film formation of transparent electrodes of solar cells, display devices such as liquid crystal displays and plasma displays, and transparent electrode layers in touch screens.

What is claimed is:

1. A method of manufacturing a transparent conductive film, comprising:
using a gaseous raw material obtained by vaporizing an organic compound selected from a zinc organic compound, a tin organic compound and an indium organic compound, and a gas containing oxygen atom,
supplying power for plasma generation to a pair of electrodes from a power circuit having a power source generating a single-frequency sine wave, and a pulse control circuit, and
generating dielectric barrier discharge at/near an atmospheric pressure to form a transparent conductive film by plasma-enhanced CVD.

2. The method of manufacturing a transparent conductive film according to claim 1, wherein said gas containing oxygen atom contains ozone.

3. The method of manufacturing a transparent conductive film according to claim 1, wherein when said power source applies a voltage between said pair of electrodes, said pulse control circuit generates at least one voltage pulse during a half cycle, and a displacement current pulse between said pair of electrodes is generated with generation of the voltage pulse.

4. The method of manufacturing a transparent conductive film according to claim 1, wherein said pulse control circuit contains at least one choke coil.

5. The method of manufacturing a transparent conductive film according to claim 4, wherein said choke coil goes into a saturated state during a pulse following a maximum pulse in which said power source applied a voltage between said pair of electrodes.

6. The method of manufacturing a transparent conductive film according to claim 1, wherein said transparent conductive film is fabricated by remote plasma.

7. The method of manufacturing a transparent conductive film according to claim 1, wherein said power source uses a power source generating a single-frequency sine wave at 20 kHz to 3 MH.

8. The method of manufacturing a transparent conductive film according to claim 1, wherein said transparent conductive film is formed with a substrate temperature at 150° C. or above.

9. The method of manufacturing a transparent conductive film according to claim 1, wherein said zinc organic compound is used as said organic compound.

10. The method of manufacturing a transparent conductive film according to claim 9, wherein said zinc organic compound is a complex compound containing Zn and Al, or a compound expressed by Zn(CₓH_{y}O_{z})ₘ.
